(19) United States
(12) Patent Application Publication
(10) Pub. No.: US 2013/0167236 A1
(43) Pub. Date: Jun. 27, 2013

(54) METHOD AND SYSTEM FOR AUTOMATICALLY GENERATING VIRUS DESCRIPTIONS

(71) Applicant: THORSTEN SICK, Ravensburg (DE)

(72) Inventor: THORSTEN SICK, Ravensburg (DE)

(73) Assignee: Avira Holding GmbH, Tettnang (DE)

(21) Appl. No.: 13/691,147

(22) Filed: Nov. 30, 2012

(30) Foreign Application Priority Data
Dec. 15, 2011 (DE) 10 2011 056 502.7

(51) Int. Cl. G06F 21/56

(52) U.S. Cl. CPC G06F 21/56
USPC 726/24

(57) ABSTRACT

Systems and methods for automatically generating information describing malware are disclosed. In accordance with certain embodiments, a client computer may be provided with an antivirus program capable of finding malware and a server for receiving malware information sent from the antivirus program via a network. In accordance with one embodiment, the antivirus program may checked the client computer for malware and, in the event that malware is found, the antivirus program may acquire information about the malware such as the type of malware, the form of identification of the malware, whether the malware has already been executed, and/or whether it has been possible to remove the malware. This malware information may be transmitted from the client computer to the server in an automatic, structured manner. When received by the server, the malware information may be fed into a database on the server and subsequently displayed, for example, in an automatic, structured manner on a web page or via an interface of the antivirus program.

### CROSS REFERENCE TO RELATED APPLICATIONS

This application claims a right of foreign priority to prior-filed German Application No. 10 2011 056 502.7, filed Dec. 15, 2011, which is hereby incorporated by reference herein in its entirety.

### TECHNICAL FIELD

Embodiments of the present invention generally relate to methods and systems to automatically generate virus descriptions and, in particular, automatically generating and setting structured, human-readable virus descriptions in a network-based portal.

### BACKGROUND

An antivirus program (also referred to as an “AV” program, virus scanner or virus protection, abbreviation: AV) is typically software application that is capable of detecting computer viruses, computer worms and Trojan horses, and that can block and, if necessary, remove rootkits and other harmful software (“malware”) not wanted by the user.

Owing to the continuous further development of malware, there is often a need for constant updating of the antivirus program and for collecting information about the malware, this normally being effected via the Internet, even several times per day if necessary. The malware in this case is collected and, for example, one or more hash values may be automatically generated in order to identify it. The generated hash values are then transferred to the computer provided with the antivirus program so that the antivirus program can identify new patterns for the malware. It should be understood that malware is not the only technology that is tracked by antivirus programs.

In principle, there may be differing types of identification carried out by the antivirus program:

Reactive: In the case of this type of identification, a malware is identified only when a corresponding signature (or known hash value) has been made available by the producer of the antivirus software. An advantage of a reactive approach is that a signature can be created in an efficient and automated manner, in order then to transmit it to the antivirus programs on the computers.

Proactive: This denotes the identification of malware without a corresponding, unique signature being available. Proactive methods may be, for instance, heuristics/generics and behavior analysis (“behavior blockers”), by which behavioral characteristics that correspond to a malware are identified. These methods make it possible to identify unknown malware for which there is no signature.

Normally, both techniques (reactive and proactive) may be employed in antivirus programs, in order to compensate for potential weaknesses of the other technique in each case.

### SUMMARY

Embodiments of the present invention may be used to simplify the preparation of the information about a given malware provided on a description page and to provide that information more rapidly via a decentralized, distributed approach, through use of the data that becomes available in user computers.

In accordance with embodiment a method to automatically generate malware information involving a client computer provided with an antivirus program for finding malware and a server for receiving digital malware information over a network may be performed by the antivirus program checking of the client computer for malware and, in the event of a malware being found, acquiring malware information relating to the manipulations by the malware on the client computer. The malware information may relate to whether the malware has already been executed as well as whether it has been possible to remove the malware. Next, this malware information may be converted into a structured format and transmitted to the server over the network in an automated manner. At the server, the malware information is received from the client computer by the server and fed into a database coupled to the server. Subsequently, the malware information may be in displayed in a structured manner on a web page or in the antivirus program via the Internet.

In one implementation, before the malware information is transferred, an interactive dialog may be started on the client computer, in which dialog requests a confirmation of the transmission of the malware information by a user, and a confirmation can be given for all subsequent requests. In another aspect, the user may be prompted in a dialog to manually input further descriptive information relating to the malware.

Alarm messages may also be generated and sent by the server. For example, alarm message may be sent if one or more of the following conditions occurs: (1) if a threshold value for the importing of malware information is exceeded within a period of time; (2) if a threshold value concerning the quantity of one type of malware is exceeded; (3) if a threshold value for a malware that cannot be removed is exceeded; and (4) if a definable control system, which is preferably based on the quantity and/or the content of the malware, triggers the alarm.

In accordance with one embodiment, the antivirus program may be composed of one or more of the following components: a file scanner component; a behavior blocker component (which performs a behavioral analysis of the file by monitoring this file as it is executed); a firewall component (which identifies a communication of executing files); a web proxy/mail proxy component (which identifies the communication from executing files); a cleaning component (which removes files, processes from the memory and registry entries); a local reputation database “LDB” component (which stores the history of a file); a system component (which collects system information relating to the client computer); and a rootkit identification component (which identifies whether a rootkit has embedded itself on the system).

In one aspect, the components may forward the collected data to a collecting interface, which then prepares this data to produce malware information and transfers it to the server. In another aspect, an expandable or extensible protocol such as JavaScript Object Notation (JSON)/Extensible Markup Language (XML) may be used to transfer and receive the data via http.

In one embodiment, encryption, signature and/or checking of multiple occurrences of the malware information or parts thereof may be performed in order to prevent false malware information from being imported.

Embodiments of the present invention may acquire one or more of the following items of malware information: File name; File path; Hash (MD5, SHA1, SHA256); File size; Identification name; Whether the malware has been executed; By which program was the malware generated and executed; Which files have been created by the malware; Operating system; URL infections; Social network infections; Presence of a rootkit on the system; Self-protection of the malware; Successfulness of cleaning; Registry keys of the malware; ITW=True (in-the-wild, found by customer); ITW counter +=1; ITW counter of successful infections +=1; Presence of propagation via Autoruninf; Presence of propagation via file infection; Presence of propagation via a website; Presence of propagation via a network; Presence of propagation via email; Presence of propagation via network directories; Presence of propagation via instant messenger; Presence of propagation via peer-to-peer; Presence of propagation via infected multimedia files; Presence of propagation via social network; Presence of modifications in host's file; Presence of registry modifications; Presence of attacks on security applications; Presence of a downloader, which downloads data from the Internet; Presence of a dropper, which inputs other files; Fake AV (malware that imitates AV software); C&C (Command and Control) information (server, etc.); Presence of open ports, messengers, social network accesses, that allow access to the client computer; Presence of propagation through mail: From, Subject; Presence of data theft; Packer information; System manipulations by the malware.

In accordance with one embodiment, a system for automatically generating malware information may be provided that includes a client computer provided with an antivirus program for finding malware and a server computer for receiving malware information. Both computers may be connected over a network. The client computer and the antivirus program may be set up and realized by software and hardware so that checking of the client computer, by the antivirus program, for malware is possible and, in the event of a malware being found, malware information may be acquired that relates to: the manipulations by the malware on the client computer; whether the malware has already been executed; and/or whether it has been possible to remove the malware. Further, the client computer and the antivirus program may also be set up to transmit the malware information to the server in an automatic, structured manner. The server may be set up and realized to receive the malware information from the client computer and to feed the malware information into a database on the server. The server may also be set up and realized to display the malware information in an automatic, structured manner on a web page or in the antivirus program.

In a possible embodiment, the client computer may be equipped to start an interactive dialog on the client computer before the malware information is transferred in which dialog requests a confirmation of the transmission of the malware information by a user. This confirmation can also be given for all subsequent requests. The client computer may be equipped to prompt the user in a dialog to manually input further descriptive information relating to the malware.

In one aspect, the server may be equipped to generate and send alarm messages if: (1) a threshold value for the importing of malware information is exceeded within a period of time; (2) a threshold value concerning the quantity of one type of malware is exceeded; (3) a threshold value for a malware that cannot be removed is exceeded; and/or (4) a definable control system, which is preferably based on the quantity and/or the content of the malware, triggers the alarm.

In a further embodiment, the antivirus program may be composed of one or more of the following components: a file scanner component; a behavior blocker component (which performs a behavioral analysis of the file by monitoring this file as it is executed); a firewall component (which identifies a communication of executing files); a web proxy/mail proxy component (identifies the communication from executing files); a cleaning component (which removes files, processes from the memory and registry entries); a local reputation database “LDB” component (which stores the history of a file); a system component, (which collects system information relating to the client computer); a cloud component (which classifies files by means of cloud technology); and a rootkit identification component (which identifies whether a rootkit has embedded itself into the system). These components may be realized so that the collected data is forwarded to a collecting interface, which then prepares this data to produce malware information and transfers it to the server.

In such an embodiment an expandable or extensible data protocol may be used to transfer and receive the data. In order to prevent false malware information from being imported, encryption, signature and/or checking of a multiple occurrence of the malware information or parts thereof may be effected. Also, it is possible for the malware information to be approved manually.

### DESCRIPTION OF THE FIGURES

For a better understanding of the various aspects and embodiments of the invention, reference should be made to the following detailed description including the following drawings:

FIGS. 1A and 1B show a representation of exemplary malware information description page that may be displayed, for example, on a server home page. FIG. 1A depicts a top portion of the description page and FIG. 1B depicts a bottom portion of the description page presented below the last row of FIG. 1A. In some embodiments, it may be a database rendered into a HTML homepage on a web server or data rendered by the user's AV scanner.

FIG. 2 shows a flow diagram of the method carried out on the client computer in accordance with an embodiment.

FIG. 3 shows a flow diagram of the method carried by on the server in accordance with an embodiment.

FIG. 4 shows an exemplary environment for implementing various embodiments.

FIG. 5 is a block diagram of an exemplary antivirus program running on a client computer in accordance with an embodiment.

FIG. 6 is a process flow diagram in accordance with an embodiment.

FIG. 7 is a schematic diagram of an illustrative network system in accordance with an exemplary embodiment.

FIG. 8 is a schematic diagram of a representative hardware environment in accordance with one embodiment.

### DETAILED DESCRIPTION

In order to make it easier for the users to understand a virus and its behavior and, if necessary, to remove it, a description page may be generated on the Internet for each harmful software/malware that is analyzed. The description page may provide tips and information relating to the associated malware. Information that may be important or useful for a user may include, for example, file names, changed files, registry entries changed by the malware, and the probabilities of successful cleaning by the antivirus program. Since malware oftentimes subsequently loads other malware on to a computer, it may also be of interest to know whether parallel infections have occurred with other users.

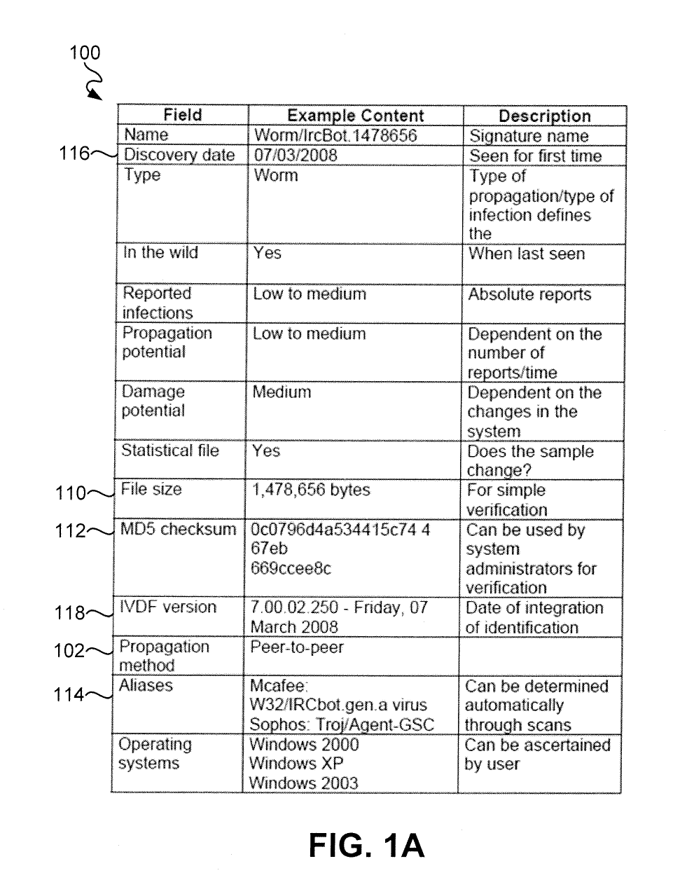

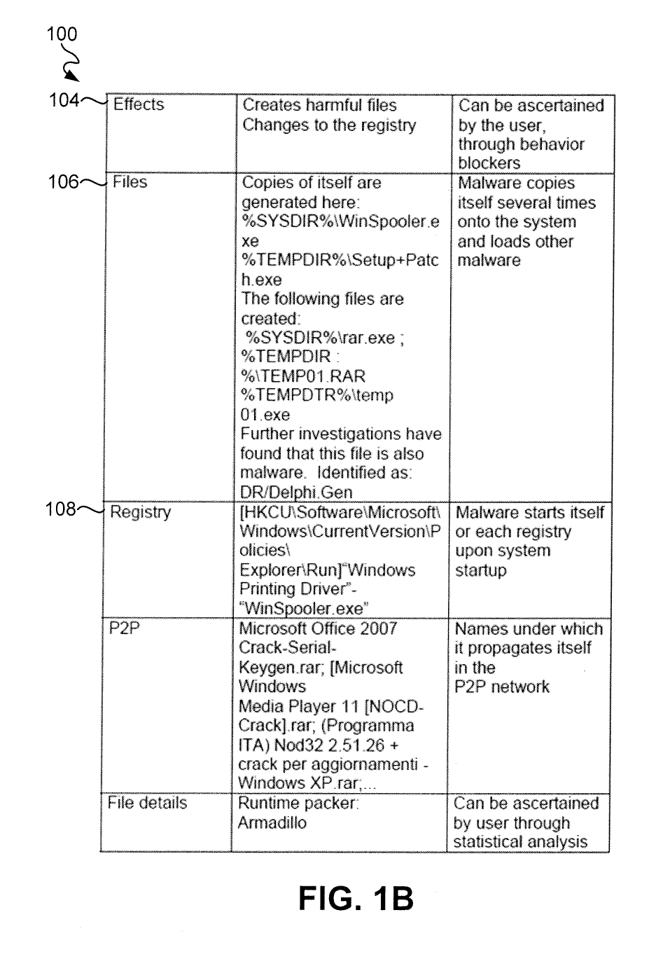

FIGS. 1A and 1B depict an example of such a description page 100 for a representative malware. An illustrative version of a description page is also available at http://www.avira.com/de/support-threats-description/tid/4666/tlang/de (in German) and http://www.avira.com/en/support-threats-description/tid/4666/tlang/en (in English) which are hereby incorporated by reference herein.

The displayed information for this exemplary description page 100 may be generated automatically, for various languages, by means of one or more files from a malware/virus database and a template. The data for the database can be manually determined in a virus laboratory, for example, by executing malware on virtual machines and observing its behavior. After the data has been determined, the data may then be entered into the database. In some embodiments, specialists may enter this data into the database manually.

When a malware has been found, the user's computer receives a link (such as, e.g., a URL) to the description page corresponding for that malware. This link can be displayed on the user's computer by the antivirus program and which may be generated from a detection name. The detection name is the name of the malware and, preferably, may be unique to the particular malware sample. The detection name may be stored in the virus database. The link to the detection name may be generated by inserting the detection name into a URL template and then saved in the virus database as part of the record associated with the given malware instance. Thus, when the link is subsequently selected by a user, the link directs the user to the corresponding description page for the malware that has been found on the user's computer. The description page may be stored online, for example, as part of the virus database (or other database in the system associated with the information contained in the virus database about the given malware). In one embodiment, the description page may be a homepage and displayed using a browser or rendered from the database on to a user interface of the AV software. In some embodiment, if there is, however, no description page because one has not yet been created for the given malware instance, the link may be directed display a default page that states “No description available” for the malware.

Manually creating the descriptions for a description page can be time-intensive and subject to frequent error. Oftentimes, there may also be too much malware for it to be possible to continue to provide the users with high-quality information using a manual approach. For example, it has been estimated that more than 50,000 hash-unique malware samples per day may be analyzed in virus laboratories and integrated into a virus identification system.

Malware information of the type shown on a description page 100 of FIGS. 1A and 1B may be of relevance to an end user following the identification of the malware of the user's computer (i.e., client computer) and before or during the cleaning of the malware from the user's computer. At this point in time, there may be little information present on the identified client computer about the given malware. For example, information about the malware may be as little as a hash, an identification name and a file name. Additional information that may possibly be present can include, for example, information concerning parallel infections and the infection path. Parallel infections can occur because many of the malwares subsequently load further malware during an infection of a computing device. For example, parallel infections are typically the main purpose of what is known in the art as “downloader”-type malware. Accordingly, it is often (if not always) the same group of, for example, five to six malware families that are to be encountered on correspondingly identified computers. Criminals in some cases receive money for each infected computer, which may explain this behavior.

After the cleaning process has removed or isolated the malware from the client computer, the following information may additionally be available on the client: modified registry keys (before and after the cleaning process), self-protection of the malware, success of the cleaning process. This information may be collected by the virus scanner/antivirus application and transferred from the client to the servers of the AV provider where the information for the description page is collected and prepared. The prepared information may then be presented to users via the exemplary description page of FIGS. 1A and 1B or some other similar form.

Ideally, all information transferred from the client computer to the AV provider's server should occur in a manner that can be confirmed or authorized by the user prior to transfer. For example, this can be either globally, as “participate in community,” or specifically, by allowing a user to approve or refuse a sending of the information to the AV provider's servers upon each detection of malware. The user may also be permitted supplement information manually (either on the description page or before posting on the user's computer). The sent information is assembled in a database relating to the malware (e.g., the malware database) and can subsequently be displayed on the malware description page.

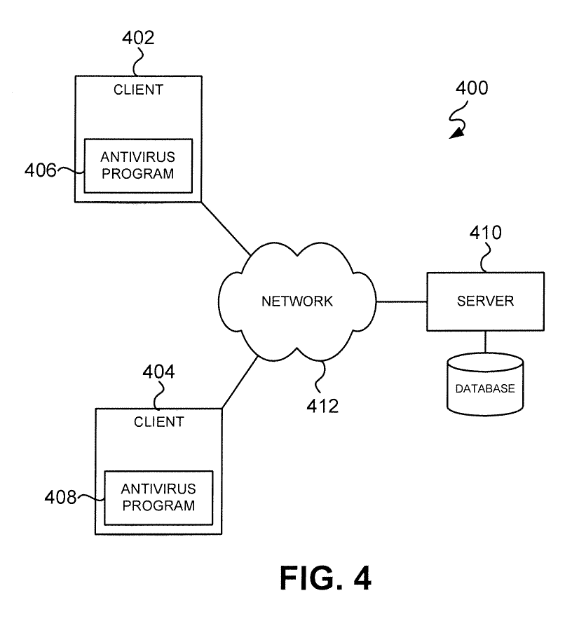

Generally speaking, embodiments of the present invention may provide a method for automatically generating malware information in the environment 400 depicted in FIG. 4. As shown in FIG. 4, the environment may include one or more client computers 402, 404 (such as, e.g., end user computers), each provided with an antivirus program 406, 408 capable of detecting malware and one or more servers 410 capable of receiving malware information from the client computer. The client and server computers 402, 404, 410 may be connected to one another via one or more networks 412 such as, for example, the Internet. The server is normally operated by the developer of the antivirus programs (i.e., the AV provider), whereas the client computer is the computer that has been infected by malware. While the antivirus program is depicted in FIG. 4 as residing on the client computer, embodiments of the present invention may also be implemented remotely from the client computer (e.g., on the server or in a cloud environment) so that the antivirus program can access, scan, inspect, analyze the client computer and files thereon remotely via a network connection between the antivirus program and the client computer.

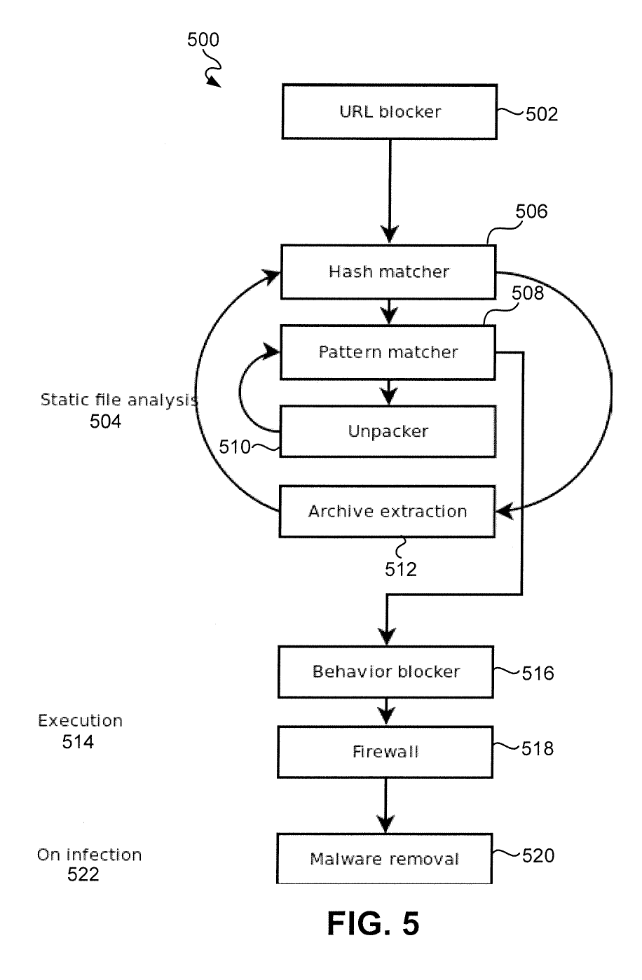

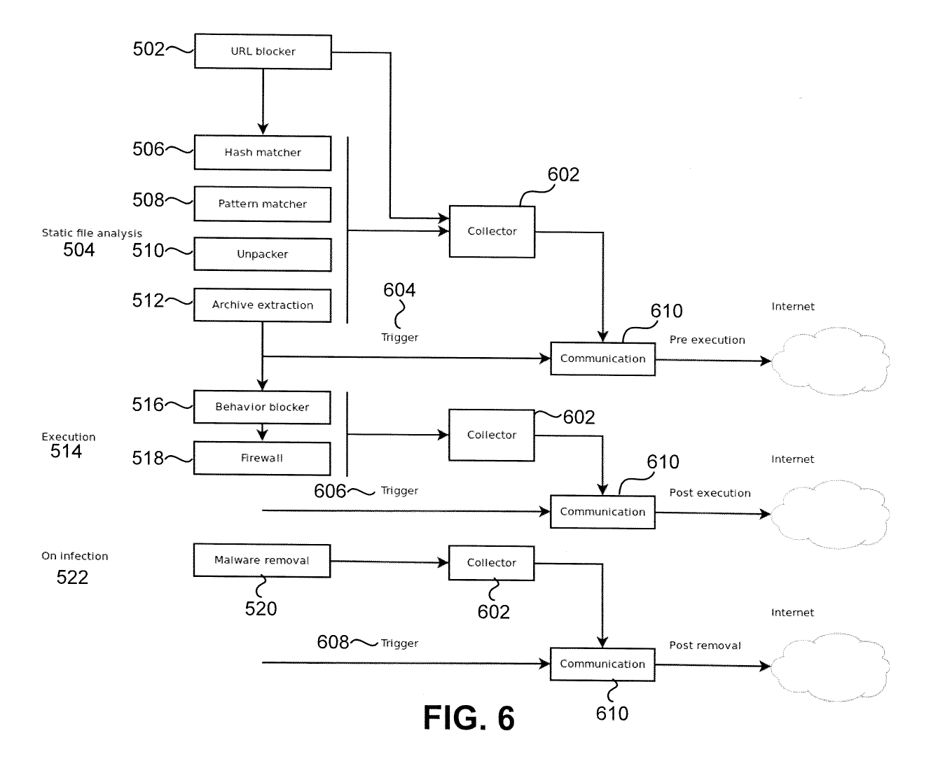

FIGS. 5 and 6 illustrating an exemplary set of components of an antivirus program 500 and process flow between those components that may be implemented in the exemplary environment depicted in FIG. 4 in order to carry out various embodiments of the present invention. The antivirus program 500 may include one or more of the following components depicted in FIGS. 5 and 6 (as well as additional components) that may be used to collect the information relating to the malware that is then to be transferred to the AV provider's server and database via a network such as the Internet.

The antivirus program 500 may include a file scanner component capable of checking the files as they are being stored or as they are being opened and/or read. In addition, regular scans may also be performed by the file scanner component in order to check the files. This is commonly referred to in the art as an on-access and on-demand/scheduled scan scenario. Both of these are available for selection in most existing antivirus programs.

The antivirus program 500 may include a URL blocker component 502 that is capable of matching URLs requested from the user's PC with a blacklist comprising set or list of blacklisted URLs. If the requested URL visited by the user matches an entry in the blacklist, then access may be blocked in order to help prevent access to and download of malicious content.

In addition, the antivirus program may include a number of components that can be used during a static file analysis phase 504 in which one or more static files may be analyzed without executing the given file(s) in order to determine whether the file(s) is or contains malware. These components may include a hash matching component 506 (“hash matcher”), a pattern matching component 508 (“pattern matcher”), an unpacking component 510 (“unpacker”), and an archive extraction component 512 (“archive extraction). The hash matcher 506 compares a hash of the sample file with a blacklist of known malicious hashes. If the hash matches one or more of the malicious hashes in the blacklist, the sampled file may be flagged as malware. The pattern matcher may be used to search for known-malicious byte patterns in the sample file. If one or more (or a predefined or certain number of) known malicious byte patterns are detected in the sample file, the file may be flagged as malware.

The unpacker 510 unpacks files that are packed with exe packers like UPX while the archive extraction component 512 extracts files from archives like ZIP, RAR files. After unpacking or extraction the sample file may be returned to the hash matcher 506 or the pattern matcher 508 (or both) for analysis by those components.

A number of other components of the antivirus program 500 can be used during an execution phase 514 during which the suspect file is executed. These components may include a behavior blocker component 516 (“behavior blocker”) and a firewall component 518 (“firewall”). In the embodiment depicted in FIGS. 5 and 6, the execution phase occurs after the suspect file has gone through the static file analysis phase (i.e., has been “cleaned” under static analysis). While in the illustrative embodiment depicted in FIGS. 5 and 6 shows that they execution phase occurs after static file analysis has classified the sample file as “clean,” it should be understood that embodiments may be implemented where execution phase analysis occurs without performing the state file phase. In any event, the execution phase occurs when the user/client computer executes the sample file.

The behavior blocker 516 performs a behavioral analysis of the file by monitoring this file as it is executed and preventing the file from causing unwanted changes to the client computer. The behavior blocker 516 observes the behavior of the sample file while it is executed. If malicious behavior is detected by the behavior blocker 516, then the execution process of the sampled file is terminated in order to prevent infection and the file flagged as malware.

Firewall 518 monitors and blocks unwanted network traffic. Communication of an executable with the Internet will be observed by this component. The firewall 518 which identifies and analyzes communications with the Internet that occurs while the suspicious file(s) is executing. If the file(s) sends abnormal protocols or ports or contents to an abnormal address on the Internet, the firewall can intervene. A corresponding function may be assumed by a web proxy/mail proxy component capable of identifying the communication from executing files at the protocol level.

The antivirus program may also include a malware removal component 520 to handle circumstances where a malware was successful in infecting the client computer (“on infection” phase 522). In these circumstances, malware removal component 520 may be used to perform file and registry disinfection so that the infecting malware and all of its modification to the infected computer are removed, disabled or isolated.

In addition to the above-mentioned components, the antivirus program 500 may include a cleaning component that is capable of removing files, processes, and/or registry entries from memory that have been identified/flagged by the other components of the antivirus programs as malware or potential malware. The cleaning component may also be capable of reporting whether removal of the suspected malware files, processes, and/or registry entries was successful. Embodiments of the antivirus program 500 may also include a local reputation database (“LDB”) which is capable of storing the access and/or change history of a file. The LDB makes it possible to ascertain changes to files, and it also makes it possible to log accesses to this file and to monitor movements within the file system.

The various components of the antivirus program 500 may be included as part of the file scanner component (i.e., subcomponents of the file scanner) and/or may be separate components that may operate either in conjunction with or independently from the file scanner.

With particular reference to FIG. 6, the antivirus program may include one or more collector components 602 that may collects information from the various other modules/components. The collector 602 may also be capable of storing the collected information for later retrieval and use.

As shown in FIG. 6, during the operation of the antivirus program 500, a number of triggers may be utilized to trigger the sending of the collected information from the collector to the AV provider/server via a network such as the Internet. A first trigger 604 may be occur after static file analysis 514 so that information collected during the static file analysis may be sent to the AV provider/server (and pre-execution of the malware). A second trigger 606 may occur on or after detection of malicious activity in the behavior blocker 516/firewall 518 so that information collected during the execution phase 514 may be sent to the AV provider/server. A third trigger 608 may occur after malware removal (i.e., on infection by the malware 522) so that information collected during/after the removal (e.g., post-removal) of the malware may be sent AV provider/server. It should be understood to one of ordinary skill in the art that the collected information may also be sent at later stages triggers instead of (or in addition to) its respective associated trigger. For example, information collected during static file analysis may be sent after the second and/or third triggers 606, 608 instead of or in addition to the time of the first trigger 604.

The antivirus program 500 may also include a communication component(s) 610 that processes the data about the malware obtained by various components of the antivirus program 500 (and collected by the collector 602), creates an information file containing the data, and then sends or transfers it to the servers via the network. As shown in FIG. 6, transmissions of data about the analyzed malware may be sent at various stages during the analysis by the antivirus program (e.g., pre-execution of the suspected file, post-execution of the file and post-removal). It should be understood that embodiments of the present invention may be implemented where the collected data about the malware are transmitted at other times such as for example, at times when network traffic is low or at periodic intervals.

The antivirus program may also include additional components. For example, a system component may be provided that collects system information relating to the client computer. This component may collect information relating to the client computer's operating system, its patch level, devices connected to the client computer, and information about events obtained from event log associated with the client computer. It should be understood by one of ordinary skill in the art that other information about the system may also be collected. Another exemplary component that may be included in the antivirus program is a rootkit identification component that identifies whether a rootkit has embedded itself on the system.

It should also be understood that some or all of the components of the antivirus program may be capable of forwarding data that they have collected from a given suspect file to the collector and/or communication components 602, 610. As previously mentioned, the collector and/or communication components 602, 610 serve as a collecting interface that is capable collecting and preparing the data and sending it to the AV provider/server via the network in order to provide the AV provider/server with information about the analyzed file/malware. In one embodiment, this interface connects to the server over a TCP/IP to a specific address associated with the AV provider/server and may send the information as a data structure with a predefined format that is readable by the server. In one embodiment, the data structure with a predefined format may comprise data in an extensible file format such as, for example, XML, HTML, or similar format. Should other components be added to the antivirus program for collecting malware information, it should be understood by one of ordinary skill in the art that these components also should be able to access the collecting interface and provide their collected data to it.

In operation, the antivirus program 500 checks its associated client computer for malware. In the event that malware is detected or found on the client computer, information about the malware (which may be referred to as “malware information”) is compiled by the antivirus program. The collected malware information may include, for example: (1) the type of malware; (2) the form of identification of the malware, (3) whether the malware has already been executed, and/or (4) whether it has been possible to remove the malware. The collected information may be transmitted automatically to the server in a structured manner (e.g., in a data structure with a predefined format). In a preferred embodiment, the data is sent in a flexible data format that can accommodate additional data/information because evolution of the malware may require extension of the collected data set. As previously, information collection and transmission/submission over the Internet may be handled by the antivirus program (or one or more components thereof). The collection and transmission may be performed as a background task on the client computer with no user interaction and can be triggered by the detection of the malware (such as, for example, use of the triggers discuss with reference to FIG. 6.)

In one preferred embodiment, the antivirus program 500 may open and display a dialog window or the like to the user of the client computer from which the malware information has been collected. The dialog window may ask the user whether the data may be transferred to the server. In one embodiment, the dialog window may display the information that is going to be sent to the server and provide the user an option to input additional information about the found malware. This information can be elicited, for example, through specific questions generated by the antivirus program and displayed to the user via dialog windows and the like. Once received by the addressed server, the malware information sent from the client computer may be stored in a database (i.e., the malware or virus database) containing information about one or more various malwares. Thus the data about the malware stored in the database can then be requested via a web page (HTML or similar protocol) that is connected to the Internet. This may be done by a security researcher or by an infected user who wants additional information on the infection/malware.

In some circumstances the malware information collected by the AV provider may become redundant. This may occur, for example, when several computers generate and send the same message/information about the same malware infection. In such circumstances, the database may issue only one of these infection patterns via the web interface in order to prevent redundancies. Internally within the AV provider, however, the database may store information about the number of client computer infections that have occurred with the given malware so that corresponding analyses and statistics are possible (e.g., frequency, distribution, or other pattern analysis about a malware infestation/infection and the spread thereof). It is thus also conceivable for the collected information to be aggregated, in order that it can be stored or displayed in an aggregated manner. In addition, in one embodiment, the virus/malware database may range from one or more simple text files to one or DBMS server parks.

The AV provider may also have corresponding trigger mechanisms running on the malware information database system that execute particular actions if certain threshold values and limit values are exceeded. These trigger mechanisms can be implemented, for example, by embedded SQL statements or by regular examination of the newly received malware information, implemented repeatedly in the database at certain points in time. Thus, alarm messages can be generated by the server and sent to employees of the producer of the antivirus software if a threshold value for the importing of malware information is exceeded within a period of time. This analysis can make it possible to ascertain whether a virus/malware is propagating vigorously and/or whether it is necessary to adapt the antivirus software in order that this particular malware infection can be suppressed. The threshold value can also be based on the quantity of one type of malware. As explained herein, the type of malware may be determined according to the form of the infection and/or according to the module that identifies the malware.

Owing to the fact that the virus signatures are frequently created on the basis of information about a large quantity of viruses that is exchanged between the producers of antivirus programs, there is often a lack of feedback to the client computer as to whether it is possible to successfully erase the identified virus(es) from an infected client computer. To that extent, the information concerning the possibility of erasure of a virus/malware may be of interest. For example, should a threshold value for a malware that cannot be removed exceed a predefined value within a period of time, a message can be sent to the developers of the antivirus software so that these developers can deal with this specific malware.

In one embodiment, encryption, signature and/or checking of a multiple occurrence of malware information or parts thereof received from the client computer may be performed by the server before storing the malware information in the database. Such checking helps to prevent false malware information from being imported into the database. Similarly, in order to prevent of attacks on the server such as (D)DOS attacks and fake data, automatic and/or manual plausibility tests can be performed on the received malware information by the server. As a result, it is possible that manual approval of the generated description may be required at the server. This approval can be made necessary or mandatory, for example, if there is a high probability (based on the type of data, for example) of infiltration by false malware information. An automatic way to handle such an “untrusted” client scenario is to automatically compare information collected on one specific malware sample on several users' computers. If the same information is collected from several computers, the information can be considered as valid. Clearly, as in the case of all data transferred from unknown users, it may be useful to have regard to SQL injection and script injection. As a result, hardening (even more than for a normal web service) of the various server components of the system may be desirable since one can expect these components to potentially be high profile targets for malware authors and other parties looking to thwart the antivirus services provided by the system. Owing to the rapid development of the malware, the identification technology of the system likewise is suited for adapting very rapidly. As a result of this, new data can be produced. Therefore, the communication protocol between the user PC and the server should ideally be flexible to handle changing data. Classical data formats that support such rapid changes include, for example, JSON and XML (as mentioned earlier). These formats can be used via HTTP and other network communication protocols.

There are many items of information relating to malware and a malware attack that may be of interest to various implementers. The following list sets forth exemplary information about a given malware (or malware attack) may be of interest in various embodiments of the present invention. Any or all of this information may be collected by the antivirus program, stored in the malware/virus database of the AV provider and displayed in a description page for a given malware instance:
File name
File path
Hash (MD5, SHA1, SHA256)
File size
Identification name
Whether the malware has been executed
By which program was the malware dropped and introduced. (This makes it possible to deduce propagation path. At present, a PDF viewer hacked through manipulated PDF files may be a typical or expected propagation path.)
Which files have been created by the malware
Operating system
URL infections
Social network infections
The presence of a rootkit on the system. (This can indicate more tenacious malware, which installs a rootkit in order to protect itself.)
Self-protection of the malware
Successfulness of cleaning
Registry keys of the malware
ITW=True (in-the-wild malware, e.g. found by customer)
ITW counter +=1

ITW counter of successful infections +=1
Presence of propagation via Autorun.inf
Presence of propagation via file infection
Presence of propagation via a website
Presence of propagation via a network
Presence of propagation via email
Presence of propagation via network directories
Presence of propagation via instant messenger
Presence of propagation via peer-to-peer networks
Presence of propagation via infected multimedia files
Presence of propagation via social networks
Presence of modifications in host's files
Presence of registry modifications
Presence of attacks on security applications
Presence of a downloader, which downloads data from the Internet
Presence of a dropper, which inputs another file
Fake AV (malware that imitates AV software)
C&C (Command and Control) information
Presence of open ports, messengers, social network accesses, that allow access to the client computer
Presence of propagation through mail: From, Subject—presence of data theft
Packer information
System manipulations by the malware

In addition to the above information, the following Table 1 (below) shows exemplary items of malware information in relation to the time of identification and to the module that has affected the identification. As discussed previously, this information may be collected by the antivirus program during analysis of a sample or suspect file and sent to the AV provider's server for storage in the virus/malware database and display on a malware description page. The “Pre/Post Cleaning” column of Table 1 distinguishes between identification “pre” and “post” time of cleaning. In general, the “pre” timeframe is the time period from when file has been downloaded but has not yet been started (i.e., has not started executing). The “post” time period spans from the point at which the malware has started (begins executing) up to and until it is subsequently disinfected. New data is produced during execution and disinfection. The “User Can Help” column indicates whether average end user (i.e., at the client computer, for example) can submit additional and valuable information. As mentioned herein, the user's help may be obtained, for example, by soliciting the user for information via simple dialog displayed/presented to the user. The “Source Module” column indicates a basic module of a default antivirus solution that may be used obtain this information from one or more analyzed files.

TABLE 1
Exemplary Malware Information

| | | User | |
|---|---|---|---|
| Malware Information | Pre/Post | Can | |
| Item | Cleaning | Help | Source Module |
| File name | Pre | No | Scanner |
| File path | Pre | No | Scanner |
| Hash (MD5, SHA1, | Pre | No | Scanner |
| SHA256) | | | |
| File size | Pre | No | Scanner |
| Identification name | Pre | No | Scanner |
| Has malware been executed | Pre | No | LDB |
| By which program has | Pre | No | LDB |
| malware been dropped | | | |
| Which files have been | Post | No | Behavior blocker |
| created by the malware | | | |
| OS | Pre | No | System |
| URL infections | Pre | Yes | LDB |
| Social network infections | Pre | Yes | Firewall/LDB |
| Rootkit on system? | Post | No | Rootkit identification |
| Other malware-hash | Pre | No | Scanner |
| Other malware-file names | Pre | No | Scanner |
| Other malware- | Pre | No | Scanner |
| identification name | | | |
| Self-protection of malware | Post | No | Cleaning |
| Successfulness of cleaning | Post | No | Cleaning |
| Registry keys of malware | Post | No | Cleaning |
| ITW = True | Pre | No | Scanner |
| ITW counter += 1 | Pre | No | Scanner |
| ITW counter of successful | Post | No | Cleaning |
| infections += 1 | | | |
| Propagation via Autorun.inf | Post | No | Cleaning |
| Propagation via file | Post | No | Scanner/Cleaning |
| infection | | | |
| Propagation via website | Pre | No | Firewall/LDB |
| Propagation via network | Pre | No | Firewall/LDB |
| Propagation via email | Pre | No | Firewall/LDB |
| Propagation via network | Pre | No | Firewall/LDB |
| directories | | | |
| Propagation via Instant | Pre | No | Firewall |
| Messenger | | | |
| Propagation peer-to-peer | Pre | No | Firewall |
| Propagation infected | Pre | No | Scanner/LDB |
| multimedia files | | | |
| Propagation social network | Pre | Yes | Firewall/LDB |
| Modifications in host's file | Post | No | Cleaning |
| Registry modifications | Post | No | Cleaning |
| Attack on security | Post | No | Behavior blocker |
| applications | | | |
| Downloader | Post | No | Firewall/Behavior |
| | | | blocker |
| Dropper (places further files | Post | No | Behavior blocker |
| as it is executed) | | | |
| Fake AV | Post | Yes | Behavior blocker |
| C&C (Command and | Post | No | Firewall |
| Control) information | | | |
| (server) | | | |
| Open ports, messengers, | Post | No | Firewall, Behavior |
| social network access, etc. | | | blocker |
| In case of propagation | Pre | No | Firewall/LDB/ |
| through mail: From, Subject | | | Behavior blocker |
| Data theft (file access) | Post | No | Behavior blocker |
| Packer information | Pre | No | Scanner |

As already explained above, the information about the malware such as the type set forth in Table 1 may be generated by the antivirus program and sent to the AV provider server/database using a structured text format (e.g., JSON/XML) data protocol via HTTP would be a suitable protocol. Despite the relative frequency of massive malware attacks, a malware detection on a private computer is nevertheless rather an exception. For this reason, the volume of data to be taken into account may not be very great. And even if it is, data packets can be discarded without any great loss. This is particularly the case if sufficient information has already been collected for the malware. In such situations, the primary interest of subsequent transmissions reporting of detected instances of the malware may simply be the fact that this given malware has again been encountered by a user and, thus, simply an “infection” counter that tracks the number of malware or infection instances can be incremented. One of ordinary skill in the art should understand that network and Internet infrastructure enables servers and other network devices to be easily scaled to handle situations of high transmission loads or continuous transmission load (e.g., load balancers and the like).

With continued reference to Table 1, the counter “ITW=True” (in-the-wild) means that the malware has been found on a client computer (in the case of a user of the antivirus program). This means that it is not an artificial malware but a real threat. The “ITW counter +=1,” refers to an ITW counter used by the system (instances may be located in the antivirus program and at the AV provider server and database) that is incremented when an instances of the corresponding malware has been found. IN a similar fashion, the “ITW counter successful infections +=1” may be incremented when an instance of the malware has not only been found but has also been executed at the reporting computer.

In addition to the information set forth in Table 1 system manipulations by the malware may be identified and reported by the antivirus program to the AV provider/server and registered in the malware/virus database. Exemplary system manipulations include changes made to files or entries made in files that are caused by the malware. Such system manipulations can be very extensive. Typical malware often creates, replaces or modify files on the infected computer—sometimes even critical system files. For example, malware often changes the registry entries of the computer's operating system (e.g., MS Windows registry). In such cases, simple deletion of the malware and its associated registry entries can render the operating system inoperable or useless. Because of the significant problems or damage such an infection can case, system manipulation information about the malware oftentimes can be the most relevant information provided to an infected user. For example, this information can be used to inform the user of what exactly the malware did to the user's computer and whether the malware's actions can be undone.

Furthermore, it is possible to use a cloud component, which classifies files by means of cloud technology. In this case, the antivirus program is permanently connected to a cloud on the Internet, from which information for identifying malware is obtained. The most simple approach to cloud antivirus would be to generate hashes on suspicious files and verify with online databases if they are known to be malware.

In one embodiment, the AV provider may have a virus laboratory department that can access and/or control the server and the malware database so that virus research experts in the virus laboratory can identify and analyze the malware reported to the AV provider. Because entries to the database can be made by the virus laboratory, in one embodiment, malware descriptions made or modified by virus laboratory experts may be given priority over automatically generated descriptions. In such an embodiment, if conflicts are identified between the virus laboratory expert's input/analysis and that of the information/analysis provided by the antivirus program at the client computer, a conflict report identifying instances of conflict or contradictory data may be generated via the database server. Such as report can be available to the experts by homepage, special analysis tool or automatically sent to the expert(s) by email or other messaging techniques.

Returning to FIGS. 1A and 1B, the content of this exemplary description page may be derived from the features of an exemplary Internet Relay Chat (IRC) bot. In such an embodiment, the information displayed on the description page can be generated from the malware/virus database that has been manually input by the virus laboratory.

As shown in FIGS. 1A and 1B, the exemplary description page may display three categories of information to the user that, for instance, can be displayed in three columns including “Field,” “Example Content” and “Description” columns. The “Description” column may contain brief comments describing the corresponding field and content. Depending on the template used to display the data, the description page may also display field and content information to the user as well as additional information/descriptions about the various entries via popup or other browser display techniques An illustrative version of a description page is available at http://www.avira.com/de/support-threats-description/tid/4666/tlang/de (in German) and http://www.avira.com/en/support-threats-description/tid/4666/tlang/en (in English) which are hereby incorporated by reference herein. Typically, the greatest benefit from the information provided in the malware will be derived by administrators and other IT personnel who have a need to understand what has infected a particular computer and how that infection occurred. Other interested users may include so-called “power users” that seek a better understanding of their computer. Accordingly, in some embodiments, the description column of a malware display page may only be displayed to users having “administrator” of similar managerial access.

The information provided by some of the exemplary fields shown in the illustrative description page of FIGS. 1A and 1B will now be described.

Propagation method 102: The propagation method field defines the way(s) the malware uses to spread to other systems. This information may be provided in the description page in order to prevent further infections with similar malware after a cleaning process.

Effects 104: The effects field identifies and describe features of the malware such as, for example, key logging or account theft. The effects field information may be used to help assess and rapidly identify potential or actual damage caused by the malware to the infected computer.

Files 106: Many types of malware create multiple files. For example, “droppers”—are a specialized type of malware that drops one or more malware files onto the victim's computer. Accordingly, the files field may be used to identify the various files and/or file names associated, created, generated with the malware so that such malware files can be identified on an analyzed computer.

Registry 108: Registry is most often used to restart the malware files after a reboot. Accordingly, the registry field may be referenced when checking the central Windows setup/registry file for malware related changes.

File size 110 and MD5 checksum 112: The information provided by the file size 110 and MD5 checksum 112 fields may be used to verify the found malware file. Hashes are often a good way to link information about a malware sample from several sources.

Alias 114: Because antivirus vendors often assign different names to the same malware (because naming is typically left to the experts in the virus labs and malware can be found in parallel by several vendors), the information provided by the alias field may include other names assigned to the malware from other AV providers, etc. This information can then be used to obtain further information about the malware from these other AV providers and sources.

The description page may also include information fields for the first detected occurrence of the malware (Discovery date 116), and the date of the published identification (IVDF version 118). A field 120 may also be include to provide additional details about the malware such as, for example, whether a runtime packer is used by the malware. The description page may also include statistical evaluations and these may be compiled and published as diagrams on the page. Such statistics can show, for example, number of infections over a defined period of time, the kind of infections, the type of operating system, etc.

The description page may also list operating system-related information that can be used to assist a user in determining whether an update to the next operating system service pack may contain protection for the malware (e.g., a security patch). For example, Microsoft service packs often add security features that interfere with known malware samples. As an option, the description page may include information about cleaning prospects for the malware. A major impact on cleaning prospects is the way a malware modifies system files. Destroying essential windows components may reduce the chances of successfully cleaning the malware from a computer. However, cleaning prospects information may oftentimes not be included on the page because the prospects may not here yet been ascertained by the virus laboratory.

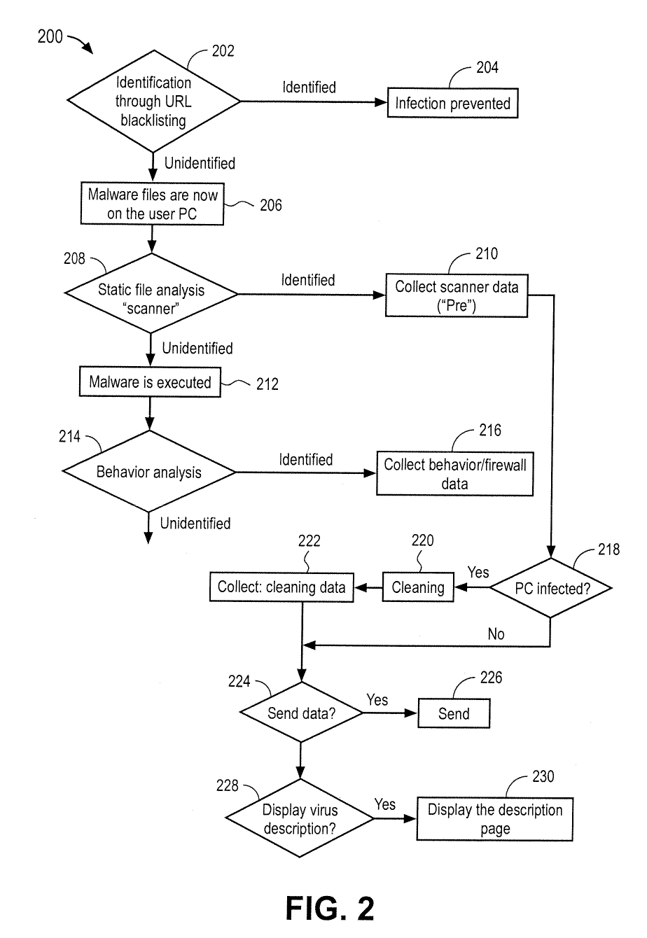

FIG. 2 shows the illustrative sequence of an infection and intervention points of an antivirus program/AV solution running on a client computer in accordance with an exemplary embodiment. In an ideal case, the malware is found at an early point in the sought infection so that the user is reliably protected. The further the infection has advanced, however, the more information about the malware may be collected.

In accordance with one embodiment, the process 200 may begin with the antivirus program conducting identification through URL blacklisting in decision 202. In decision 202, the antivirus checks one or more URL blacklists of sources for malware and allows the antivirus program to block the access to malicious content (infection prevented 204) if the antivirus program identifies the URL as matching one of the URLs on the blacklist.

Next, if the URL source of the downloaded file is not blocked from the URL blacklisting, the malware may be downloaded to the user's PC so that the malware file(s) is now on the user PC (block 206) but not yet executed at this stage. In decision 208, static file analysis is performed—typically as part of the scanning process of the file carried out by the antivirus program. In static analysis, the antivirus program analyzes files without them being executed. This analysis may include, for example, file hashes, pattern matching, unpacking and emulation of the suspicious file. If the file is identified as malware during static file analysis 208, then the antivirus program collects (block 210 pre-execution data about the file it obtains during the static file analysis scanning of the file. Typically, the “pre-execution” data collected during the scanning/analysis process 208 is less data than that collected during behavior analysis (decision 214 below). If the sample is classified as malware by static analysis, then subsequent execution of the malware execution may be prevented so that the only collected data about the malware during this analysis on this computer is the data collected in block 210.

After static file analysis 208, if the malware file is actually executed (block 212), then the antivirus program may conduct behavior analysis (decision 214) the file(s) being analyzed. Execution of the malware 212 typically occurs when file is executed by the client computer. If the file is malware, execution of the file may allow the malware to modify the client computer unless it is blocked or aborted early in the execution process.

In behavior analysis 214, a behavior blocker (or similar technology) of the antivirus program monitors the file as it is being executed and intervenes in the event of the file is detected doing anything suspect. As mentioned previously, firewall-related analysis may also occur during decision 214. If the file is identified as malware during behavior (and firewall) analysis 214, then data about the file obtained during the analysis may be collected in block 216.

If the malware is successfully executed on the user's computer (PC infected? Decision 218), the antivirus program may subsequently clean the computer to remove the malware and changes to the computer made by malware in cleaning operation 220. During cleaning the processes, files and registry entries created by the malware are removed. This can be affected by means of a specific script for the malware or, in many cases, can also be affected very successfully by means of a generic automatic tool.

If so, data about the malware obtained during the cleaning process (i.e., data resulting from system cleanup and malware removal) may also be collected in operation 222.

In decision 224, data collected from blocks 210, 216, and 222 may be processed and sent to AV provider/server via the network at the appropriate time and circumstances (send data block 226). As discussed herein, in order to provide users enhanced transparency and control of the data the antivirus program may include settings for controlling transmission and sharing of the collected data (e.g., “participate in community” option or querying the user separately for each data packet sent). In the individual querying situation, when data is ready to be sent, the program may display the data to be sent to the user to give the user authorization power to send and, optionally, allow the user the possibility of adding additional information to the transmitted data (e.g., comments). Because of the volume of the malware and the rapid frequency of new malware releases, the transfer of information when required maybe the most appropriate way of offering current information to the user.

In decision display virus description 228, the user should have the possibility of displaying a description of the malware (irrespective of the user decision concerning sending of the data). Display of the description page 230 can be realized in the browser (e.g., through a specific URL) or can be directly embedded in the AV antivirus program. The information displayed in the description page may include data collected from the analysis set forth of FIG. 2, as well as information sent to the antivirus program from the AV server/database via the network.

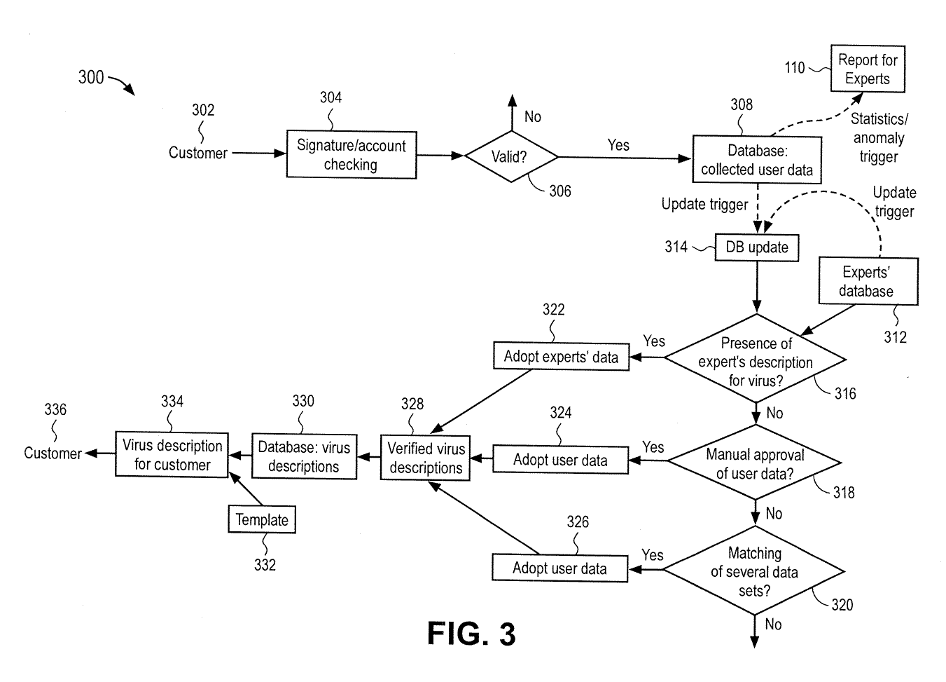

FIG. 3 is a flowchart of an exemplary process 300 on the server side in accordance with an embodiment of the invention. The AV provider side may include one or more servers running DBMS and/or scripts handling the processing of the incoming data received from the client computer. In one embodiment, the databases and servers of the AV provider to collect and prepare information and generate, as automatically as possible, a high-quality virus/malware description. In addition, warnings and statistics may be generated and transmitted to other computers as may be desired. The entry point for this process is data being received from client computers via the network (customer 302). This data may be the data collected by the antivirus program from the client computer and sent to the AV provider in operation 226 of FIG. 2.

During the signature/account check procedure 304, a check is affected in order to verify the client in order to make sure that the data is being received from a legitimate client and not a spoof. This procedure is intended to sift out false data although it may not guarantee whether the data is actually usable. If the client is determined to be a valid source (decision 306), then the received data is stored in the virus/malware database in operation 308. In operation 310, reports may be generated from the data in the database for use by experts and other sources. In one embodiment, the generation of these reports may be triggered if threshold values in the database are exceeded or if a statistic is queried. These reports may then be used by AV experts so that they may be able to intervene in the process (e.g., in the case of the threshold values) or obtain an overview (e.g., in the case of the statistic).

The system may include an experts' database 312 which may comprise a description database managed by AV experts. The content of this database may be verified and confirmed as plausible. The data in the experts' database 312 may be collected from the virus/malware data in a database update process 314. This process 314 may be triggered by a variety of conditions such as, for example, upon a command by an expert or through a period or event trigger.

Next, in decision 316, a check of the database for the presence of experts' description for the virus/malware may be performed. An experts' description is one produced by an AV expert in the virus laboratory and are typically considered the most valid descriptions about the malware/virus. In decision 318, a manual approval of user data may be performed in which user data is verified and approved by experts in the virus laboratory. In decision 320, a check to determine whether there are any matching of several data sets for the malware/virus in which an automatic verification is performed using several user datasets as source. If any of the checks in decisions 316, 318, 320 are “true” then the appropriate data may be adopted for incorporation into the malware/virus description page in operations 322 (adopt experts' data), 324 (adopt data received from user/client computer), and 326 (adopted user data found to be matching several data sets). As shown by the order of decisions 316, 318, 320, the system may impose a hierarchy over the sources of data used for the malware description page with the expert descriptions having priority over manual approval of the collected user data and verification by means of matching of the data sent by a plurality of customers.

Next, in operation 328, a verified virus description that describes the virus/malware is generated from the possible sources (i.e., via operations 322, 324, 326). This description may then be stored in a database of virus descriptions 330. The database of virus descriptions is controlled and/or part of the AV provider server and may be accessed by customers via the appropriate queries (from, e.g., the customer's AV program or customer's browser). This data is combined with the appropriate template 332 so that the appropriate malware description page 334 (containing the data from the database in the format proscribed by the template) can be sent to and displayed at the client computer (via output 336). In one embodiment, the template is used for localization into a language appropriate for display on the client computer. The virus description for the customer may be displayed in the customer's browser or in the customer's AV program and are intended to help the customer to understand the detected malware/virus that attacked the customer's computer.

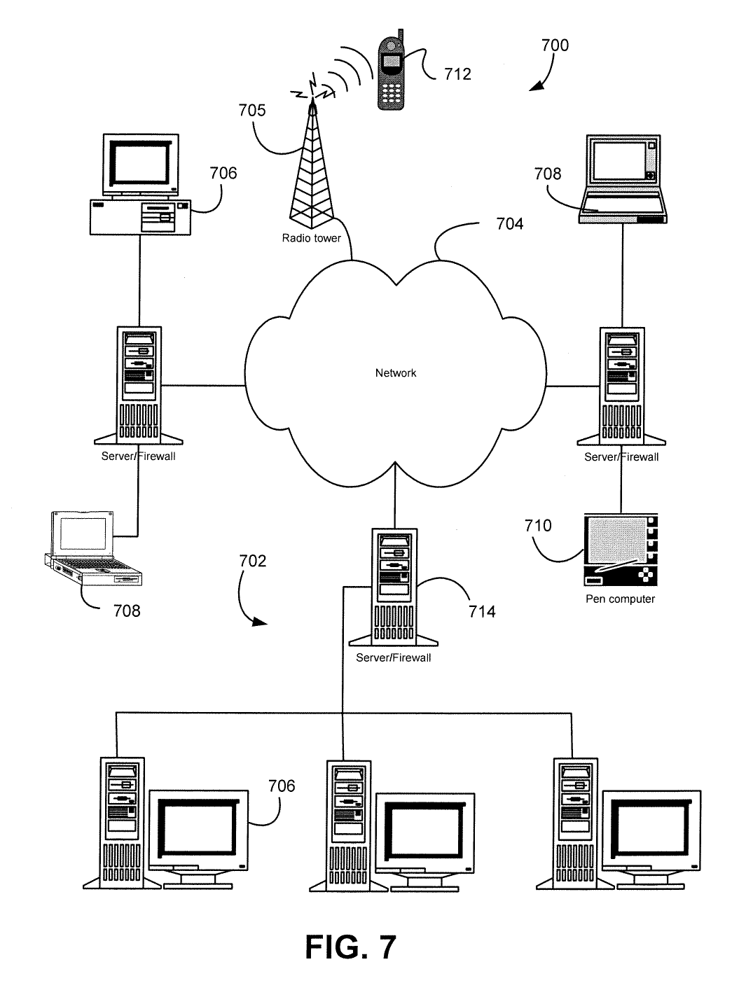

FIG. 7 illustrates an exemplary network system 700 with a plurality of components 702 that may be used when implementing various embodiments described herein. As shown, such components include a network 704 which take any form including, but not limited to a local area network, a wide area network such as the Internet, and a wireless network 705. Coupled to the network 704 is a plurality of computers which may take the form of desktop computers 706, lap-top computers 708, hand-held computers 710 (including wireless devices 712 such as wireless PDA's or mobile phones/smart phones), or any other type of computing hardware/software. As an option, the various computers may be connected to the network 704 by way of a server 714 which may be equipped with a firewall for security purposes. It should be noted that any other type of hardware or software may be included in the system and be considered a component thereof.

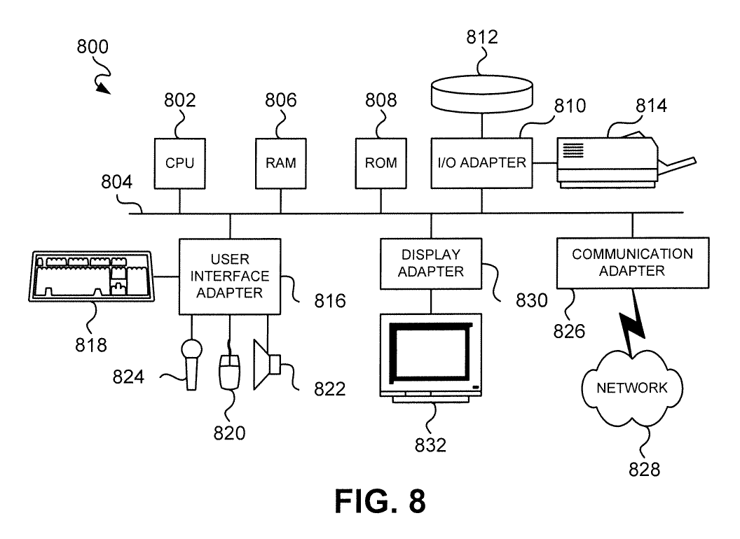

A representative hardware environment associated with the various components of FIG. 7 is depicted in FIG. 8. In the present description, the various sub-components of each of the components may also be considered components of the system. For example, particular software modules executed on any component of the system may also be considered components of the system. In particular, FIG. 8 illustrates an exemplary hardware configuration of a computer 800 having a central processing unit 802, such as a microprocessor, and a number of other units interconnected via a system bus 1204. The illustrative computer 800 shown in FIG. 8 includes a Random Access Memory (RAM) 806, Read Only Memory (ROM) 808, an I/O adapter 810 for connecting peripheral devices such as, for example, disk storage units 812 and printers 814 to the bus 804, a user interface adapter 816 for connecting various user interface devices such as, for example, a keyboard 818, a mouse 820, a speaker 822, a microphone 824, and/or other user interface devices such as a touch screen or a digital camera to the bus 804, a communication adapter 826 for connecting the computer 800 to a communication network 828 (e.g., a data processing network) and a display adapter 830 for connecting the bus 804 to a display device 832. The computer may utilize an operating system such as, for example, a Microsoft Windows operating system (O/S), an Apple O/S, a Linux O/S and/or a UNIX O/S. Those of ordinary skill in the art will appreciate that embodiments may also be implemented on platforms and operating systems other than those mentioned. One of ordinary skilled in the art will also be able to combine software with appropriate general purpose or special purpose computer hardware to create a computer system or computer sub-system for implementing various embodiments described herein. It should be understood the use of the term logic may be defined as hardware and/or software components capable of performing/executing sequence(s) of functions. Thus, logic may comprise computer hardware, circuitry (or circuit elements) and/or software or any combination thereof.

Embodiments of the present invention may also be implemented using computer program languages such as, for example, ActiveX, Java, C, and the C++ language and utilize object oriented programming methodology. Any such resulting program, having computer-readable code, may be embodied or provided within one or more computer-readable media, thereby making a computer program product (i.e., an article of manufacture). The computer readable media may be, for instance, a fixed (hard) drive, diskette, optical disk, magnetic tape, semiconductor memory such as read-only memory (ROM), etc., The article of manufacture containing the computer code may be made and/or used by executing the code directly from one medium, by copying the code from one medium to another medium, or by transmitting the code over a network.

Various systems, methods, and computer program products on a computer readable storage medium for causing a computer to perform a method may be implemented in accordance with the various embodiments described herein. For example, a server may be provided that has a component coupled to a network to permit the receiving, via the network, of one or more messages containing information describing one or more aspects of a malware detected on a remote computer by an antivirus program.

In some embodiments, the antivirus program may be running on the remote computer while in others, the antivirus program may be located a remote connection from the remote computer so that it analyzes the malware on the remote computer via the network. The malware may be detected at the remote computer by the antivirus program through an analysis of the malware. In particular, the analysis by the antivirus program may include an analysis of a suspected malware before it is executed, an analysis of the malware upon execution on the client computer, and an analysis after the malware has infected the client computer. The antivirus program may include a number of components for carrying out its analysis of the malware. For example, the antivirus program may include a URL blocker capable of determining whether the suspected malware is associated with a blacklisted uniform resource locator. The antivirus program may also include hash matcher and/or a pattern matcher capable of performing static file analysis of the malware. As another example, the antivirus program may include a behavior blocker capable of performing behavior analysis of the malware and/or a firewall that is capable of identifying and analyzing communications over the network occurring when the malware is executing. In addition, the antivirus program may include a malware removal component that is capable of removing or isolating the malware from the client computer.

In addition to the above-mentioned detecting or scanning components, the antivirus program may a collector capable of collecting information about the malware and a communication component that is capable of generating the message containing information describing one or more aspects of the malware from the collected information. Some embodiments, the antivirus program may generate the message (e.g., using the communication component) so that the information contained in the message is in a structured, extensible format. For example, embodiments may be implemented where the information is provided in JSON or XML formats.

The antivirus program may also include functionality that permits it to query a user of the client computer in order to have the user authorize the information contained in the message as well as authorize the sending of the message.

With respect to the server, the server may also include the capability to confirm that the message is a valid message from the remote computer. In addition, the server may be capable of storing the received information about the malware in an entry in a database that is associated with the malware. The server may also be capable of updating the entry in the database associated with the malware each time a message containing information about the malware is received. In certain embodiments, the information about the malware stored in the database may include information from an antivirus expert that describes the malware. The information about the malware stored in the database may also include information contained the message that has been approved by an antivirus expert. In some embodiments, the information about the malware stored in the database may include information concerning multiple instances of the malware. The database may further include a description database that is managed and/or controlled by one or more antivirus experts. The server may also be capable of generating one or more reports containing information about the database and sending the report to an antivirus expert. For example, a report may be generated when an anomaly in the information about the malware is detected in the database or to provide statistics relating to the malware.

The server may also be capable of retrieving information about the malware from the database as well as being capable of generating a description page describing the malware using the retrieved information and a template. In some embodiments, the generated description page is in a structured, extensible format. In some embodiments, the generated description page may be in a JSON format or a XML format.

The communication component of the server may also be capable of sending the description page via the network to the remote computer so that the description page can be display at the remote computer. As mentioned previously, in some embodiments, the description page may be displayed at the remote computer using a browser.

While various embodiments have been described, they have been presented by way of example only, and not limitation. Thus, the breadth and scope of any embodiment should not be limited by any of the above described exemplary embodiments, but should be defined only in accordance with the following claims and their equivalents.

What is claimed:

1. A method, comprising:
receiving via a network a message containing information describing one or more aspects of a malware detected on a remote computer by an antivirus program;
storing the received information about the malware in an entry in a database that is associated with the malware;
retrieving information about the malware from the database;
generating a description page describing the malware using the retrieved information and a template; and
sending the description page via the network to the remote computer for display at the remote computer.

2. The method of claim 1, wherein the antivirus program runs on the remote computer.

3. The method of claim 1, wherein the antivirus program is located at a location remote from the remote computer and analyzes the malware on the remote computer via the network.

4. The method of claim 1, wherein the malware is detected at the remote computer by the antivirus program through an analysis of a suspected malware before it is executed, an analysis of the malware upon execution on the client computer, and an analysis after the malware has infected the client computer.

5. The method of claim 1, wherein the malware is detected at the remote computer by the antivirus program through an analysis of the malware.

6. The method of claim 5, wherein the analysis by the antivirus program includes determining whether the suspected malware is associated with a blacklisted uniform resource locator.

7. The method of claim 5, wherein the analysis by the antivirus program includes a static file analysis of the malware.

8. The method of claim 5, wherein the analysis by the antivirus program includes a behavior analysis of the malware.

9. The method of claim 5, wherein the analysis by the antivirus program includes identifying and analyzing communications over the network occurring when the malware is executing.

10. The method of claim 5, wherein the analysis by the antivirus program includes cleaning the client computer to remove or isolate the malware.

11. The method of claim 1, wherein the antivirus program collects information about the malware, and the message containing information describing one or more aspects of the malware is generated from the collected information.

12. The method of claim 1, wherein the information contained in the message is in a structured, extensible format.

13. The method of claim 1, wherein the antivirus program queries a user of the client computer to authorize the information contained in the message.

14. The method of claim 1, wherein the antivirus program queries a user of the client computer to authorize sending the message.

15. The method of claim 1, further comprising confirming that the message is a valid message from the remote computer.

16. The method of claim 1, wherein the information about the malware stored in the database includes information from an antivirus expert describing the malware.

17. The method of claim 1, wherein the information about the malware stored in the database including information contained the message that has been approved by an antivirus expert.

18. The method of claim 1, the information about the malware stored in the database including information concerning multiple instances of the malware.

19. The method of claim 1, further comprising generating one or more reports containing information about the database and sending the report to an antivirus expert.

20. The method of claim 19, wherein the report is generated when an anomaly in the information about the malware is detected in the database.

21. The method of claim 19, wherein the report provides statistics relating to malware.

22. The method of claim 1, wherein the database includes a description database managed by an antivirus expert.

23. The method of claim 1, wherein the generated description page is in a structured, extensible format.

24. The method of claim 1, wherein the generated description page is in a JSON format.

25. The method of claim 1, wherein the generated description page is in a XML format.

26. The method of claim 1, wherein the description page is displayed at the remote computer using a browser.

27. A system, comprising:
a server having a component coupled to a network to permit the receiving, via the network, a message containing information describing one or more aspects of a malware detected on a remote computer by an antivirus program;
the server being capable of storing the received information about the malware in an entry in a database that is associated with the malware;
the server being capable of retrieving information about the malware from the database;
the server being capable of generating a description page describing the malware using the retrieved information and a template; and
the server having a communication interface being capable of sending the description page via the network to the remote computer for display at the remote computer.

28. A computer program product embodied on a computer readable storage medium for causing a computer to perform a method, comprising:
receiving via a network a message containing information describing one or more aspects of a malware detected on a remote computer by an antivirus program;
storing the received information about the malware in an entry in a database that is associated with the malware;
retrieving information about the malware from the database;
generating a description page describing the malware using the retrieved information and a template; and
sending the description page via the network to the remote computer for display at the remote computer.
